(19) United States
(12) Patent Application Publication
(10) Pub. No.: US 2011/0254212 A1
(43) Pub. Date: Oct. 20, 2011

(54) Wood kindling hand tool

(76) Inventor: Stephen B. Collins, (US)

(21) Appl. No.: 13/066,457

(22) Filed: Apr. 14, 2011

Related U.S. Application Data
(60) Provisional application No. 61/342,411, filed on Apr. 14, 2010.

(51) Int. Cl. B25B 11/00

(52) U.S. Cl. 269/3

(57) ABSTRACT

A wood kindling hand tool has a handle and a head. The head includes spikes that may be driven into a piece of wood to securely hold the wood steady while a user chops the wood.

### CROSS-REFERENCE TO RELATED APPLICATIONS

The present application claims the filing date of Provisional U.S. Patent Application Ser. No. 61/342,411 filed Apr. 14, 2010 entitled “Wood Kindling Hand Tool”, which Provisional Application is incorporated herein by reference and hereby expressly abandoned upon the filing of the present application.

### BACKGROUND OF THE INVENTION

The present invention relates to hand tools, and more particularly to a hand tool that is useful to assist a user in chopping firewood for kindling.

People are constantly warned to be careful when chopping wood. Accidents with axes are one of the leading causes of injuries for people who provide their own wood, and especially while camping for those who chop wood for kindling. Most people who make little sticks, i.e., kindling, out of big sticks, such as chunks of firewood or logs, hold the firewood chunk upright on a chopping block with one hand and take a good swing at the firewood chunk with an axe or hatchet. The danger is inherently obvious, as you have a sharp bladed instrument moving at high speed in the direction of the hand holding the firewood. This can result in severe damage to hands, especially fingers, when the user misses. Currently the only “hand tool” that is useful for splitting firewood with minimal danger to the hand is a froe, which replaces the axe. The iron blade of the froe is driven into the firewood, using another piece of firewood as a mallet, for example, and then torque is applied using the wooden handle to complete the split. This requires more strength than just chopping the firewood with an axe, and also takes more time.

There are several different forms of tools for splitting logs and cutting kindling, but they tend to be relatively massive and unwieldy as well as expensive. There is no hand tool currently available for use in kindling wood that can be used safely with an axe or hatchet.

### BRIEF SUMMARY OF THE INVENTION

Accordingly the present invention is a wood kindling hand tool that may be used safely with an axe or hatchet in chopping firewood for kindling. The tool has a handle and a head. The head has spikes on one side that may be driven into a piece of firewood to hold the firewood from turning. The user holds the tool with one hand, which is away from the firewood, and chops the firewood with the axe to produce the kindling. A cutaway in the head provides space for knocking the tool free from the firewood when finished, if necessary. A taper at the front edge of the head serves to deflect the axe away from the user if the user misses the log and hits the tool instead.

The objects, advantages and other novel features of the present invention are apparent from the following detailed description when read in conjunction with the attached drawing figures and appended claims.

### BRIEF SUMMARY OF THE DRAWING FIGURES

FIG. 1 is a perspective view of a wood kindling hand tool according to the present invention.

FIG. 2 is a top view of the wood kindling hand tool according to the present invention.

FIG. 3 is a bottom view of the wood kindling hand tool according to the present invention.

FIG. 4 is a front view of the wood kindling hand tool according to the present invention.

FIG. 5 is a side view of the wood kindling hand tool according to the present invention.

FIG. 6 is an illustrative view of the use of the wood kindling hand tool for chopping splits from a log according to the present invention.

FIG. 7 is an illustrative view of the use of the wood kindling hand tool for chopping splits into fine kindling according to the present invention.

FIG. 8 is a bottom view of an alternative embodiment for the wood kindling hand toot according to the present invention.

### DETAILED DESCRIPTION OF THE INVENTION

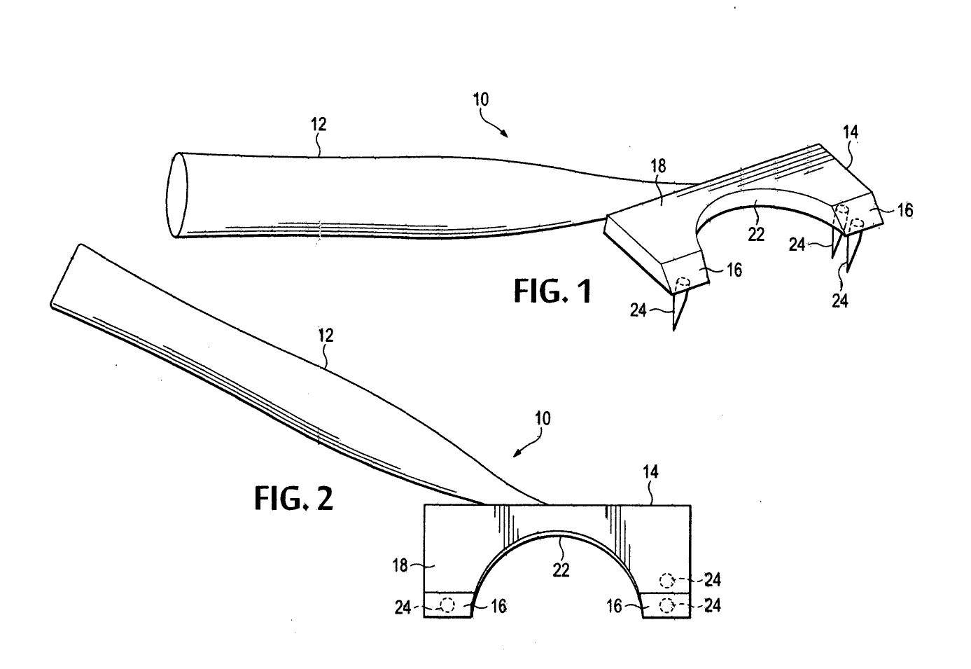

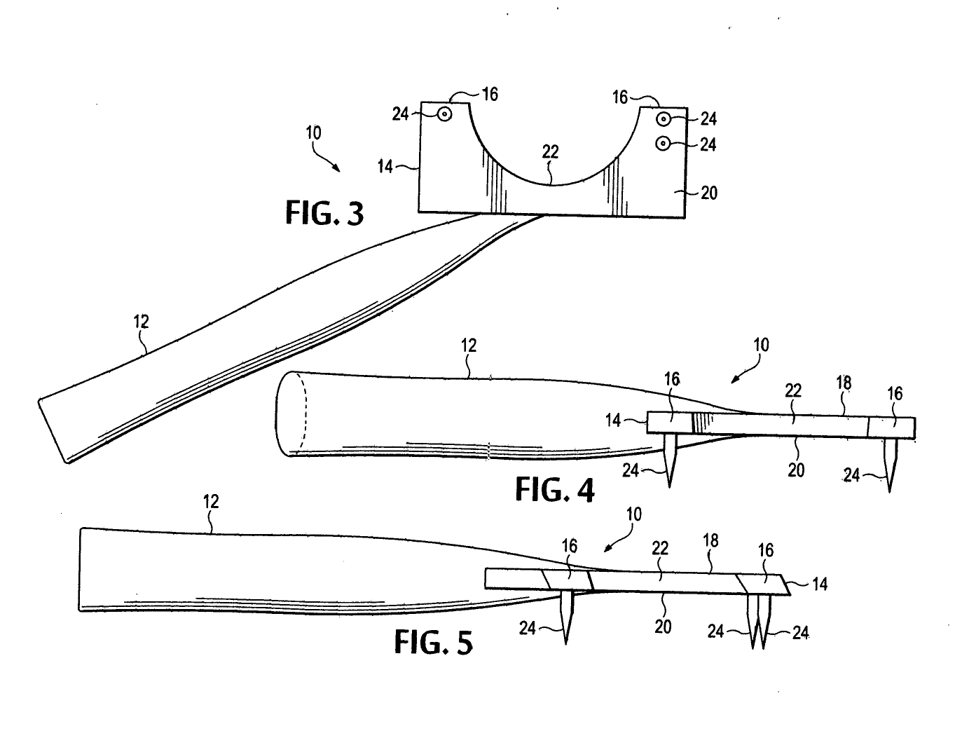

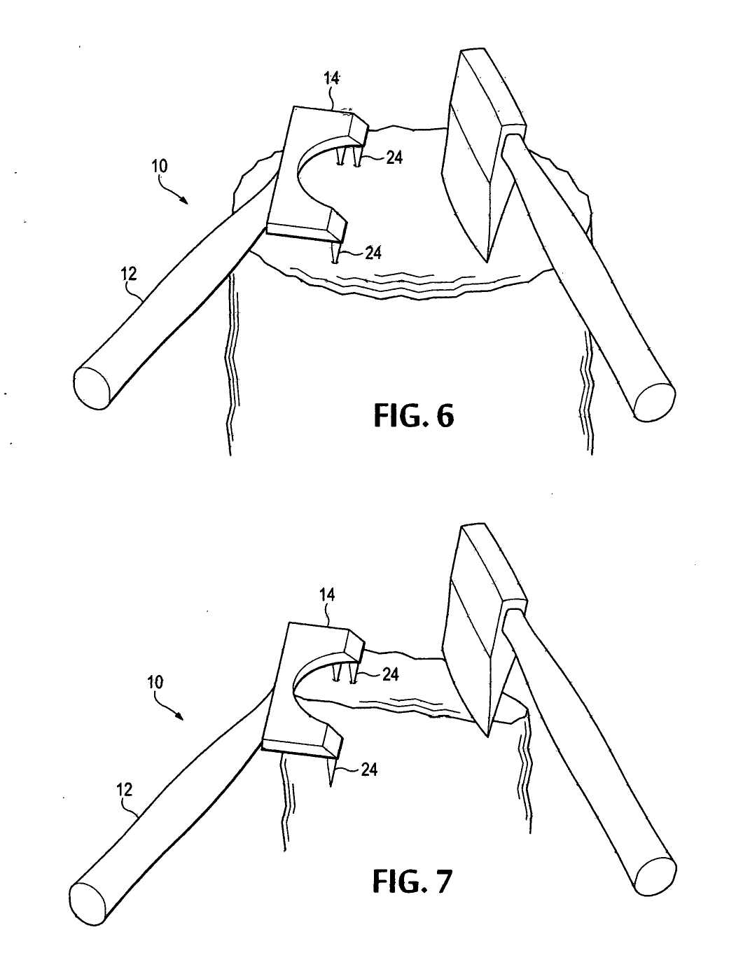

Referring now to FIGS. 1-5, a wood kindling hand tool 10 is shown having a handle 12 and a head 14. The head 14 is securely coupled to the handle 12 by any suitable means including rivets, screws, nuts and bolts and the like, but preferably the head and handle are formed as a unitary whole. If the handle 12 is a separate unit from the head 14, then the handle may be made of a different material from the head and may include a tang for forming the joint that couples the head and handle together. The handle 12 may be formed to conform to a person's hand, may be striated or may have a leather or molded cover to assure a firm grip by the user. Preferably the head 14 is made of a hard material that does not deform or fracture when accidentally struck by an axe or hatchet. Such materials include iron and metal iron alloys, such as steel, as well as synthetic materials that have similar characteristics. The handle 12 and head 14 are offset at an angle that makes it convenient for the user, i.e., places the user within convenient distance from the firewood while holding the wood kindling tool and chopping the firewood.

A front edge 16 of the head 14 is tapered from top 18 to bottom 20 so that, if a user accidentally hits the head with the axe, the axe is deflected away from the handle 12. A cutout 22 at the front edge 16 of the head 14 may be provided to allow room for knocking the firewood from the wood kindling hand tool when chopping is completed. On the bottom 20 of the head 14 are a plurality of spikes 24 that may be driven into a piece of firewood to hold the firewood steady when the user is chopping. Two spikes 24 are spaced at opposing sides of the front edge 16 so that, when driven into the firewood, the firewood is prevented from turning while the user is chopping. A third spike 24 adjacent one of the first two spikes may be provided for chopping splits from the firewood into smaller pieces, if desired. Again the two adjacent spikes 24 are driven into the split to prevent the split from turning while the user is chopping.

As shown in FIG. 6 for splitting a firewood log, the wood kindling hand tool 10 placed on one edge of the log and the spikes 24 are driven into the log to hold it securely while the user chops the log into splits with the axe. Then, as shown in FIG. 7, the wood kindling hand tool 10, after being freed from the last portion of the log, is placed at one end of one of the splits with the two adjacent spikes 24 being driven into the split to hold it securely while the user chops the split into finer kindling. The result is a safe, fast and easy method of chopping a firewood log into kindling without endangering the user's hand.

Although as shown in FIGS. 1-5 the head 14 is rectilinear in shape, any more freeform shape may be used, so long as the spikes 24 are situated in a similar position as shown with the rectilinear shape so as to prevent the wood from turning. Also the cutout 22, if provided, may be any reasonable shape other than the arcuate shape shown.

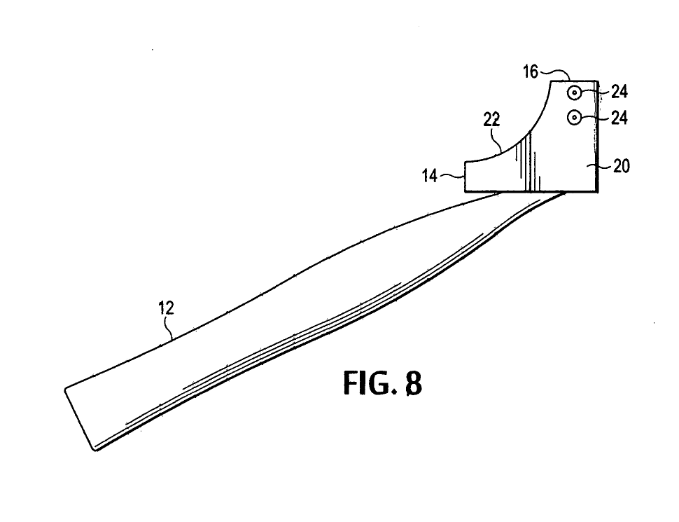

FIG. 8 shows a simpler design for the wood kindling hand tool that makes it even easier to knock the firewood off the spikes 24. Again there is the handle 12 that preferably is integral with the head 14. However in this instance the head 14 is more in the form of a square with the cutout 22 being more like the quarter arc of a circle at a corner of the square opposite the handle 12. Since the firewood tends to flex when trying to knock it off the spikes 24, the simpler design with just the two adjacent spikes 24 avoids the firewood from getting caught by the opposing spike shown in FIGS. 1-5 while still preventing the firewood from turning when chopping.

Thus the present invention provides a wood kindling hand tool that is safe and easy to use, the hand tool having a handle and a head with spikes protruding from the bottom, which spikes are driven into the firewood to hold the firewood securely while a user chops the firewood into smaller pieces with an axe.

What is claimed is:

1. A wood kindling hand tool comprising:
a head having a top surface and a bottom surface with at least two spikes protruding from the bottom surface; and
a handle coupled to a back edge of the head at a convenient angle for use.

2. The wood kindling hand tool as recited in claim 1 wherein the head further has a front edge tapered from the top surface to the bottom surface.

3. The wood kindling hand tool as recited in claim 1 wherein the head has a cutout at the front edge.

4. The wood kindling hand tool as recited in claim 1 wherein the handle is coupled to the head as a unitary whole.

5. The wood kindling hand tool as recited in claim 1 wherein the head comprises a hard material that does not deform or fracture when struck.

6. The wood kindling hand tool as recited in claim 5 wherein the hard material comprises a material selected from the group consisting of iron and iron alloys.

7. The wood kindling hand tool as recited in claim 1 wherein the handle is formed to conform to a user's hand.

8. The wood kindling hand tool as recited in claim 1 wherein the handle has a cover to assure a firm grip by a user.

9. The wood kindling hand tool as recited in claim 1 wherein the handle has striations to assure a firm grip by a user.

10. The wood kindling hand tool as recited in claim 1 wherein the head is rectilinear in shape and the at least two spikes are at opposing ends of the rectangle.

11. The wood kindling hand tool as recited in claim 10 wherein at least a third spike protrudes from the bottom adjacent one of the at least two spikes.

12. The wood kindling hand tool as recited in claim 11 wherein the head includes a cutout in a front edge of the head.

13. The wood kindling hand tool as recited in claim 12 wherein the cutout is arcuate in shape.

14. The wood kindling hand tool as recited in claim 1 wherein the head is approximately square in shape and the at least two spikes are adjacent each other.

15. The wood kindling hand tool as recited in claim 14 wherein the head includes a cutout at one corner of the square opposite the handle.

16. The wood kindling hand tool as recited in claim 15 wherein the cutout is arcuate in shape.
